(19) United States
(12) Patent Application Publication
(10) Pub. No.: US 2021/0331364 A1
(43) Pub. Date: Oct. 28, 2021

(54) PLASTICIZING SCREW FOR A MOLDING MACHINE

(71) Applicant: ENGEL AUSTRIA GmbH, Schwertberg (AT)

(72) Inventor: Guenther KLAMMER, Aschbach Markt (AT)

(21) Appl. No.: 16/881,701

(22) Filed: May 22, 2020

(30) Foreign Application Priority Data
Apr. 24, 2020 (DE) 102020111225.4

(51) Int. Cl. B29C 45/50; B29C 45/62; B29C 45/60

(52) U.S. Cl. CPC B29C 45/50; B29C 45/60; B29C 45/62

(57) ABSTRACT

A plasticizing screw for a molding machine, includes a base element which is stretched along a longitudinal axis and a screw tip which is connected to the base element, and the screw tip is located after the base element. A return flow shut-off device includes a first anterior limit stop, a second posterior limit stop, and a shut-off ring movable in a limited manner between the two limit stops along the longitudinal axis. The first, anterior limit stop comprises a first limit stop surface facing towards the base element and the shut-off ring. The shut-off ring comprises a ring-shaped screw tip abutting surface facing towards the first, anterior limit stop. The screw tip abutting surface is formed rotationally symmetric around the longitudinal axis, and the first limit stop surface comprises a convex curvature facing towards the shut-off ring.

### BACKGROUND OF THE INVENTION

The present invention concerns a plasticizing screw for a molding machine, in particular an injection molding machine or an injection press, comprising a base element which is stretched along a longitudinal axis, a screw tip which is connected to the base element, wherein the screw tip is arranged—in the direction of injection—after the base element, a return flow shut-off device, wherein the return flow-shut off device comprises a first—in the direction of injection—anterior limit stop, a second—in the direction of injection—posterior limit stop and a shut-off ring being movable in a limited manner between the two limit stops along the longitudinal axis. The at least one first, anterior limit stop comprises a first limit stop surface facing towards the base element and the shut-off ring, the shut-off ring comprises a ring-shaped screw tip abutting surface facing towards the first, anterior limit stop, and the screw tip abutting surface is formed rotationally symmetric around the longitudinal axis. In addition, the invention concerns an injection aggregate for a molding machine, comprising a plasticizing cylinder and a plasticizing screw rotatably arranged inside the plasticizing cylinder—in particular the plasticizing screw being movable along the longitudinal axis. Further, the invention concerns a molding machine comprising a closing unit and such an injection aggregate.

In order to carry out the melting and forwarding of plastic material usually plasticizing screws are used in molding machines. For molding machines, in particular injection molding machines, a valve in the form of a so-called return flow shut-off device is frequently used for the injection process. Such a return flow shut-off device comprises a screw tip and a, in particular cylinder-shaped or sleeve-shaped, shut-off ring which is movably supported between two limit stops. The shut-off ring has a closing and sealing function during the injection. In other words, a return flow shut-off device is arranged in the anterior region of the plasticizing screw in order to also allow the plasticizing screw to carry out the injection. The return flow shut-off device prevents a backflow of melt when the plasticizing screw is carrying out a forward movement (injection movement) along the longitudinal axis. When metering, however, the plasticizing screw together with the return flow shut-off device is moving backwards, wherein the melted plastic material can freely flow through the shut-off ring and flows via the channels in the screw tip into the screw pre-chamber. These channels of the screw tip are formed between radially protruding wings of the screw tip.

An example of a non-generic return flow shut-off device is disclosed in the EP 0 212 224 B1, according to which the movability of the shut-off sleeve is limited by an entrainment member which is formed by a pin. A pressing surface for the pin is formed on the shut-off sleeve. In the lateral view of the shut-off sleeve the pressing surface is a curved line and causes a guide path control of the shut-off sleeve by the pins. On each end of the pressing surface a cam is arranged on the shut-off sleeve. These cams form a final limit stop for the pin and cause the closing of the shut-off sleeve. By way of these cams and the guide path control this shut-off sleeve, thus, does not comprise a rotationally symmetric abutting surface (which is formed around the longitudinal axis) for the pin.

The DE 102 41 262 B4, the DE 10 2007 036 441 B3 and the EP 0 853 541 B2 each show return flow shut-off devices with cylinder-shaped or sleeve-shaped shut-off rings. Each screw tip comprises several, radially protruding wings. Each of these wings forms an anterior limit stop for the shut-off ring.

In the case of return flow shut-off devices known in the prior art with wings in the region of the screw tip, the plasticizing screw rotates with a certain angle and a certain speed about one point in the plasticizing cylinder when metering. At the same time, however, depending on the friction conditions the shut-off ring is usually jointly rotated with a lower rate of rotation or is even stationary. Under these conditions, a sliding friction occurs between the shut-off ring and the wing surface (anterior limit stop). Moreover, the plasticizing screw and the shut-off ring make spatial roll off movements because of the ring gap and the play of the plasticizing screw. This movement is similar to a tumbling motion. In the case of known return flow shut-off devices, the anterior limit stops (wing surfaces) are formed evenly or cone-shaped, so that high specific loads are transmitted on the edges of the sliding surfaces during the deflections or tumbling motions respectively. This can lead to damages and to a premature breakdown of the return flow shut-off device.

### SUMMARY OF THE INVENTION

The object of the present invention, thus, is to provide an improved plasticizing screw. In particular, the known disadvantages shall be removed. Especially, few damages as possible shall occur in the region of the return flow shut-off device. The duration of use of the return flow shut-off device shall be extended.

This is solved by a plasticizing screw with a first limit stop surface comprising a convex curvature facing towards the shut-off ring. As a consequence, a consistent surface load and a higher service life is reached.

Basically, it is possible that the first limit stop surface is ring-shaped and comprises only few axial holes or drills for the passage of the melt. Preferably, however, it is provided that the screw tip comprises several radially protruding wings, preferably the wings having constant distances to each other. For example, three, four of five wings can jointly form the screw tip.

Further, preferably each wing jointly forms a first, anterior limit stop.

In addition, preferably each wing comprises a surface which is remote from the first, anterior limit stop. This surface jointly forms the conically shaped tip of the screw tip. Preferably, this surface is inclined by an angle between 20° and 45° to the longitudinal axis.

Further, preferably each wing has opposing lateral surfaces which limit and jointly form the longitudinal channels arranged between the wings. The lateral surfaces can be formed evenly. Preferably, the lateral surfaces are formed bent in a cross-sectional plane rectangular to the longitudinal axis, wherein the distance between the two opposing lateral surfaces becomes smaller in the outward radial direction. This means, the wings are thicker in the area which is nearer to the longitudinal axis than in the region which is further afar from the longitudinal axis.

In particular, it is provided that each wing is approximately fin-shaped in a longitudinal section.

Per se, the plasticizing screw can be formed in one piece. For a simple production and for an easier assembling it is preferably provided that the base element and the screw tip are formed as separate components, wherein the screw tip is detachably connected to the base element, preferably by means of a screw connection.

The base element is that region of the plasticizing screw in which the plastic material (mostly in the form of granules) is melted. For the melting and forwarding of the plastic material it is provided that a helical screw flight is formed on the base element. A screw channel is formed between the screw flights.

The convex curvature of the first limit stop surface is formed in such a way that a ball-like support or contact is reached which allows a tilting of the components (shut-off ring and screw tip respectively) in all directions. As a consequence, a constant surface pressure in line with a Hertzian pressure can be reached. Hertzian pressure is defined as the largest mechanical stress which is present in the center of the contact surface of two elastic objects (in this case the shut-off ring and the first limit stop of the screw tip).

According to a preferred embodiment, the convex curvature is formed in such a way that in a sectional plane which includes the longitudinal axis the first limit stop surface at least in sections forms a convex curve. The term “at least in sections” means that the first limit stop surface can also comprise even regions. If necessary, even concave part regions can be provided.

In order to reach a uniform roll off movement between the shut-off ring and the first limit stop surface, preferably the convex curve has a continuous radius, preferably between 10 mm and 700 mm. Thus, the convex curve describes a pitch circle.

The size of the radius of the convex curvature or of the convex curves can depend on the size of the plasticizing screw. This means, the larger the plasticizing screw, the larger the radius of the convex curvature or the convex curve. Usually, the size of the plasticizing screw is defined by its nominal diameter. Preferably, the radius of the convex curve is in a range between 0.5 times the nominal diameter of the plasticizing screw and 2.5 times the nominal diameter of the plasticizing screw. This means, in a presumed nominal diameter of 100 mm the radius is in a range between 50 mm and 250 mm.

The convex curve can have at least two curve sections with different radii. Preferably, a first curve section—arranged on a radially inner position relative to the longitudinal axis—has a larger radius than a second curve section arranged on a radially outer position relative to the longitudinal axis. This means, the first limit stop surface is curved stronger in the region further afar from the longitudinal axis than in the region neared to the longitudinal axis. Of course, these curve sections can be arranged the other way round.

Further, preferably the convex curvature is formed in such a way that in a sectional plane—which is formed as a cylinder jacket around the longitudinal axis—the first limit stop surface at least in sections forms a convex curve. This applies for a sectional plane in the form of a cylinder jacket which penetrates the first limit stop surface at a position where the shut-off ring contacts the first limit stop surface. In order to reach a consistent roll off movement between the shut-off ring and the first limit stop surface, it is preferably provided that the convex curve has a continuous radius, preferably between 10 mm and 700 mm. Thus, the convex curve describes a pitch circle. It can also be provided that the convex curve has at least two curve sections with different radii. Preferably it is provided that a first curve section which is arranged centrally between the lateral surfaces of the wing (which jointly forms the first limit stop surface) has a smaller radius than two second curve sections which are arranged nearer at the lateral surfaces. This means, the first limit stop surface is flatter or less curved in a region which is near to the lateral surfaces than in the central region. However, if applicable, this can also be the other way round.

The convex curvature can be formed in such a way that (as described)
in a sectional plane which includes the longitudinal axis the first limit stop surface at least in sections forms a convex curve
or in a sectional plane—which is formed as a cylinder jacket around the longitudinal axis—the first limit stop surface at least in sections forms a convex curve.

If only one of these two variants is implemented in the first, anterior limit stop surface, this curvature is only pronounced in one direction so that a line load (and no point load) occurs in a direction which is oriented substantially rectangular to the direction of the curvature. Therefore, if only the first variant is provided, the first limit stop surface is at least section-wise in the form of a cylinder jacket (or torus-shaped), and the axis of this cylinder is rectangular to the longitudinal axis and is radially distanced from this longitudinal axis (or the circular axis of the torus is formed around the longitudinal axis). If only the second variant is provided, the first limit stop surface is at least region-wise formed as cylinder jacket, wherein the axis of this cylinder is oriented rectangular to the longitudinal axis and is running through the longitudinal axis.

Preferably, however, both variants are implemented in the convex curvature. This results in a region-wise spherical or ball-formed surface of the first, anterior limit stop surface.

In particular, the sphere-like surfaces can be formed in such a way that the centers of these sphere-like surfaces are not located in a plane which includes the longitudinal axis, whereby a plastic material film occurs which has a pulling effect onto the film in the rotary direction of the plasticizing screw. Thus, a hydrodynamic lubricating film emerges which prevents a direct contact of the surfaces.

Preferably, in assembled state and in unloaded state each wing—especially each limit stop surface formed on the wing—has the smallest distance to the shut-off ring (substantially) in its center. The center or center point can be defined as that point on the wing surface facing towards the shut-off ring which all-round has the largest distance to the edge of the wing surface (or limit stop surface). The point which is nearest to the shut-off ring, however, is not necessarily corresponding with this center point (which has the largest distance to the edge). Rather, this point which is nearest to the shut-off ring can be located in a—around the center point—circular surface field on the limit stop surface, wherein the size of this circular surface filed occupies at maximum 15%, preferably at maximum 7%, of the size of the entire limit stop surface.

Further, preferably, starting from this center point (which is nearest to the shot-off ring), the distance of individual points on the limit stop surface is steadily increasing. Specifically, this increase can be in the form of a spherical surface. The center point or the point which is nearest to the shut-off ring, thus, is a kind of a pole.

As the point which is nearest to the shut-off device is located on a (partial) spherical surface, there is also a geometric sphere center point of this (partial) spherical surface. The minimal distance of this sphere center point from the longitudinal axis should deviate by maximally 25%, preferably by maximally 10%, from the minimal distance of the point (which is nearest to the shut-off device) from the longitudinal axis.

Preferably, the sphere center point has the same distance from the longitudinal axis as the point of the limit stop surface which is nearest to the shut-off ring.

Preferably, the point which is nearest to the shut-off ring and the longitudinal axis are located in one plane, and the point which is nearest to the shut-off ring has a minimal distance from the longitudinal axis. The distance of the sphere center point from said plane amounts for maximal 50%, preferably maximal 15%, of said minimal distance.

Preferably, the sphere center point is located in said plane.

Particularly preferred, the sphere center point and the point which is nearest to the shut-off ring are located on a straight line which is parallel to the longitudinal axis.

Preferably, the limit stop surface comprises layers with different hardness. Particularly preferred, three layers with different hardness are provided. Preferably, these layers—preferably starting from the point which is nearest to the shut-off ring—are arranged in concentric circles. The nearer the layer is located at the point which is nearest to the shut-off ring, the higher is its hardness.

The details described in the previous paragraphs are always referring to an individual wing and its limit stop surface. Preferably, it is provided that concerning the above-mentioned matters all wings have the identical characteristics or properties.

Concerning the (partial) sphere form of the limit stop surface it shall be quoted that this surface is not necessarily corresponding to an exact sphere surface. Rather, the limit stop surface region-wise can also be in the form of an ellipsoid.

The screw tip abutting surface can have a concave curvature in order to reach a clinging of the screw tip abutting surface (gliding surface) of the shut-off ring to the first, anterior limit stop surface. This concave curvature can also describe a ring-shaped section of a negative torus surface or a ring-shaped section of a negative, preferably spherical, calotte. In this context, “negative” means that this surface is bent inside and, thus, (at least region-wise) corresponds to the inner surface of a jacket of a torus or of a calotte. The concave curvature of the screw tip abutting surface can also be—at least section-wise—formed correspondingly to the first limit stop surface of the first, anterior limit stop.

In contrast to this (rather theoretical) variant, however, it is provided that the screw tip abutting surface is evenly formed. Particularly preferred, the even screw tip abutting surface forms a plane which is oriented rectangular to the longitudinal axis

For the design of the shut-off ring it is preferably provided that the shut-off ring—additionally to the screw tip abutting surface—comprises a ring-shaped base element abutting surface facing towards the second limit stop, an outer surface in the form of a cylinder jacket and an inner surface in the form of a cylinder jacket. Thus, the shut-off ring forms a shut-off sleeve.

All of the substantial components of the plasticizing screw are made of metal, preferably high-grade steel. Particularly preferred, it is provided that the at least one first, anterior limit stop comprises a laser armor.

All of the details concerning the plasticizing screw mentioned in this specification are relating to a brand new plasticizing screw which is delivered from the factory. During operation, of course, there is abrasion which affects the form and surface of the plasticizing screw. This means, during operation especially the surfaces which abut each other can change because of the high loads.

Protection is also sought for an injection aggregate for a molding machine, comprising a plasticizing cylinder and a plasticizing screw according to the invention rotatably arranged inside the plasticizing cylinder—in particular the plasticizing screw being movable along the longitudinal axis. In addition, protection is also sought for a molding machine comprising a closing unit and such an injection aggregate.

### BRIEF DESCRIPTION OF THE DRAWINGS

Further details and advantages of the present invention are described more fully hereinafter by means of the specific description with reference to the embodiments by way of example illustrated in the drawings, in which:

FIG. 1 is a schematic side view of a molding machine together with an injection aggregate,

FIG. 2 is a partial longitudinal section through the return flow shut-off device during metering,

FIG. 3 is a partial longitudinal section through the return flow shut-off device with an exaggerated tumbling or wobbling motion,

FIG. 4 is a front view of the screw tip,

FIG. 5 is the cross section A-A according to FIG. 4,

FIG. 5a is an alternative detail to FIG. 4,

FIG. 6 is the cross section B-B according to FIG. 4,

FIG. 7a+7b are perspective views of the screw tip without shut-off ring from different points of view,

FIG. 8 is a simplified and perspective view of the convex curvature of the first limit stop surface,

FIG. 9+10 are simplified and perspective views of the convex curvature of the first limit stop surface with further details and

FIG. 11 is a longitudinal section similar to FIG. 3 with three layers with different hardness.

### DETAILED DESCRIPTION OF THE INVENTION

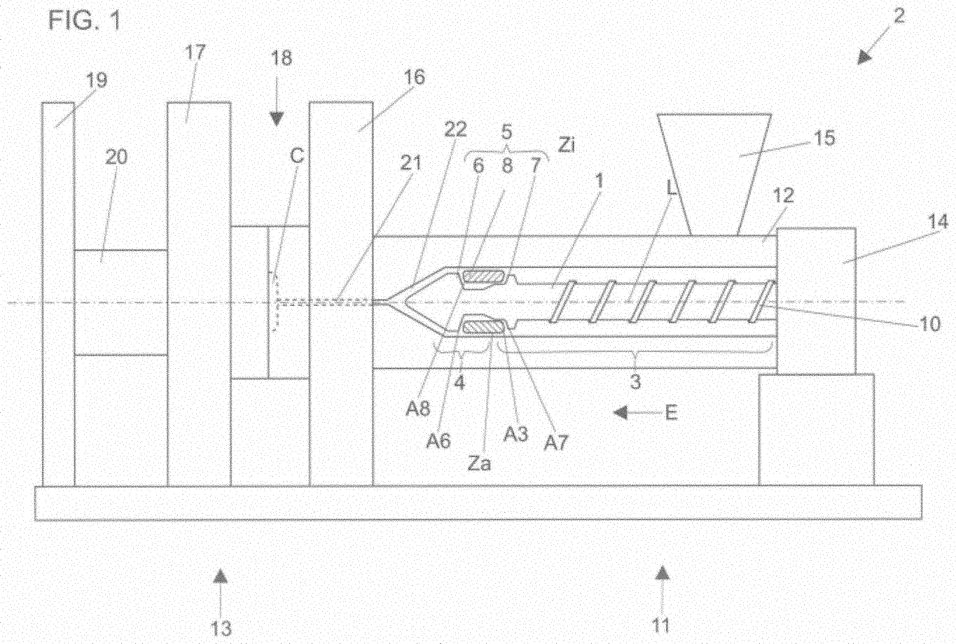

In FIG. 1, a molding machine 2 is illustrated schematically. This molding machine 2 comprises a closing unit 13 and an injection aggregate 11.

The closing unit 13 comprises a stationary mold mounting plate 16, a movable mold mounting plate 17, a mold tool mounted to the mold mounting plates 16 and 17, a front plate 19 and a drive device 20 for the movable mold mounting plate 17. In the closed state of the mold tool 18 a cavity C is formed in the mold tool 18.

The injection aggregate 11 comprises a plasticizing cylinder 12 and plasticizing screw 1 which is movably supporter in the plasticizing cylinder 12. The plasticizing screw 1 is—about the longitudinal axis L—rotatably supported in the plasticizing cylinder 12. In addition, the plasticizing screw 1 is linearly movable in the direction of injection E along the longitudinal axis L. The plasticizing screw 1 is driven by a, preferably electromotive, drive device 14. The injection aggregate 11 also comprises a feed hopper 15 by way of which raw plastic material, preferably in the form of granules, can be fed into the plasticizing cylinder 12. The raw plastic material is melted in the region of the screw flights 10 by rotating the plasticizing screw 1 and by heating the plasticizing cylinder 12. For the injection of the raw plastic material melted to a melt, the plasticizing screw 1 is moved in the direction of injection E, whereby the melt is injected through the screw pre-chamber 22 via the injection channel into the cavity C.

The plasticizing screw 1 comprises the base element 3 and the screw tip 4. These two components can be formed in one piece. Preferably, these two components are formed as separate parts which are detachably connected to each other. In the region of the base element 3, for example, a helical screw flight 10 is formed. The screw tip 4 comprises a return flow shut-off device 5. This return flow shut-off device 5 comprises a first, in the direction of injection E anterior limit stop 6, a second, in the direction of injection posterior limit stop 7 and a shut-off ring 8 which is movable in a limited manner between the two limit stops 6 and 7 along the longitudinal axis L. The first, anterior limit stop 6 comprises a first limit stop surface A6 for the shut-off ring 8, the limit stop surface A6 is facing towards the base element 3 and the shut-off ring 8. The shut-off ring 8 comprises a ring-shaped screw tip abutting surface A8 facing towards the first, anterior limit stop 6, wherein the screw tip abutting surface A8 is formed rotationally symmetric around the longitudinal axis L. The shut-off ring 8—additionally to the screw tip abutting surface A8—comprises a ring-shaped base element abutting surface A3 facing towards the second limit stop 7 (together with the second abutting surface A7), an outer surface Za in the form of a cylinder jacket and an inner surface Zi in the form of a cylinder jacket.

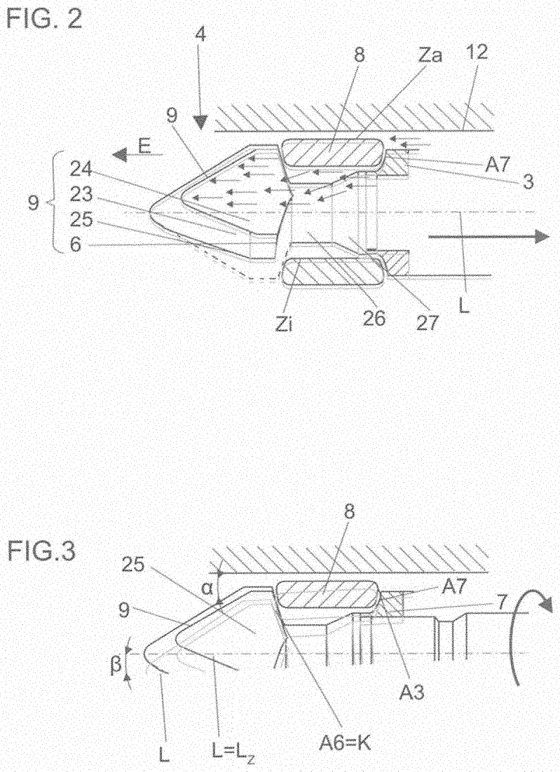

FIG. 2 shows the screw tip 4 in a side view; the shut-off ring 8 and the plasticizing cylinder 12 are illustrated sectioned. It is visible that the outer surface Za of the shut-off ring 8 in the form of a cylinder jacket is distanced from the inner wall of the plasticizing cylinder 12 by the distance s. The shut-off ring 8 abuts with its, preferably even, screw tip abutting surface A8 the first limit stop surface A6 of the first, anterior limit stop 6. In the shown embodiment the screw tip 4 comprises several radially protruding wings 9 which are arranged at constant distances to each other. Each of these wings 9 forms a first, anterior limit stop 6. These wings 9 comprise—in addition to the first, anterior limit stop 6—a surface 23 (which jointly forms the conically formed tip of the screw tip 4) being remote from the first, anterior limit stop 6 and the opposing lateral surfaces 24 and 25, which limit and jointly form the longitudinal channels passing between the wings 9. Preferably, this surface 23 is inclined to the longitudinal axis L by an angle between 20° and 45°. In this FIG. 2 (and also in further Figures) the distance between the shut-off ring 8 and the first, anterior limit stop 6 and the second, posterior limit stop 7 is relatively small because of the schematic illustration. In real, these distances—and thus the scope of movement for the shut-off ring 8—are substantially larger.

In FIG. 2, the injection aggregate 11 is carrying out the metering. This metering takes place in that the plasticizing screw 1 is moved backwards relative to the plasticizing cylinder 12 (see the large arrow), thus, contrary to the direction of injection E. As a consequence, the melt located in the region of the screw flights 10 of the base element 3 are pressed forward in the direction of injection E (see the multitude of small arrows). By way of the melt pressure, the shut-off ring 8 is moved forward in the direction of injection E relative to the plasticizing cylinder 12 until the screw tip abutting surface A8 abuts the first limit stop surface A6 of the first, anterior limit stop 6. As a consequence, the melt can first flow through the gap between the shut-off ring 8 and the second limit stop surface A7. Then, the melt flows between the shut-off ring 8 and the smaller neck region 26 of the screw tip 7 and reaches—via the longitudinal channels limited by the wings 9—the screw pre-chamber 22. This metering is carried out until the plasticizing screw 1 has reached its rearmost position and the screw pre-chamber 22 is completely filled with melt.

For the injection the plasticizing screw 1 is then moved relative to the plasticizing cylinder 12 in the direction of injection E. The shut-off ring 8 (initially) cannot be jointly moved with the plasticizing screw 1 because of the melt located in the screw pre-chamber 22, so that the shut-off ring 8 reaches a position in which the base element abutting surface A3 abuts the second limit stop surface A7 of the second, posterior limit stop 7 of the return flow shut-off device 5. A return flow of the melt into the region of the base element 3 is prevented by way of this abutting. The entire melt located in the screw pre-chamber 22, thus, can be injected (for example after opening a shut-off needle which locks the injection channel 21) into the cavity C by a movement of the plasticizing screw 1 in the direction of injection E.

In FIG. 3 it is illustrated how relative movements between the components can occur especially during metering and a simultaneous rotary movement of the plasticizing screw 1 (see large arrow) because of the relative fast movements and because of the prevailing pressure in the plasticizing cylinder 12. Especially, tumbling motions occur. On the one hand, the plasticizing screw can carry out a tumbling motion about the longitudinal axis L_{Z} of the plasticizing cylinder 12. This means, the longitudinal axis L of the plasticizing screw 1 deviates from the longitudinal axis L_{Z} of the plasticizing cylinder 12 or tumbles around this axis. This tumbling motion is illustrated by the (exaggerated) angle β. On the other hand, also the shut-off ring 8 of the return flow shut-off device 5 can carry out a tumbling motion about the longitudinal axis L_{Z} of the plasticizing cylinder 12 and/or about the longitudinal axis L of the plasticizing screw 1. This tumbling motion is illustrated by the (exaggerated) angle α. By way of these tumbling motion(s) high surface loads occur especially in the case of previously known return flow shut-off devices 5 because of deviations and deflections between the shut-off ring 8 and the first, anterior limit stop 6, which can lead to a premature malfunction of the return flow shut-off device 5.

In order to counteract this disadvantage, it is visible in FIG. 3 to some extent that the first limit stop surface A6 of the first, anterior limit stop 6 comprises a convex curvature facing towards the shut-off ring 8. As a consequence, a constant surface load as possible and a higher lifetime is reached. Specifically, the convex curvature is formed in such a way that in the section plane—which forms the sheet plane in FIG. 3 and includes the longitudinal axis L—the first limit stop surface A6 at least section-wise forms a convex curve K.

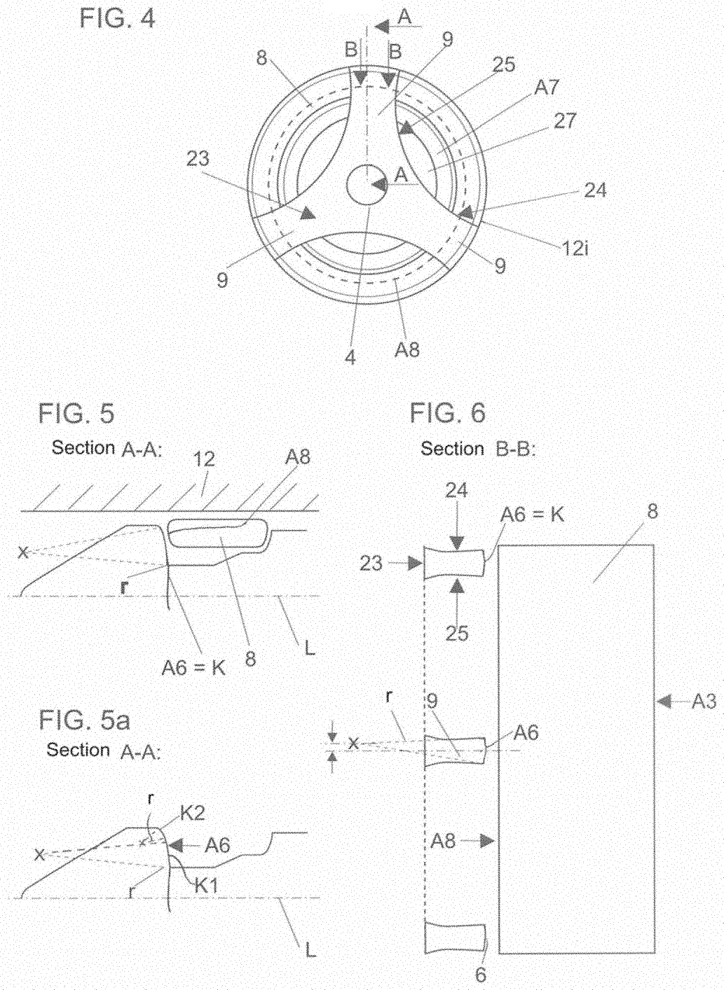

FIG. 4 shows a front view of the plasticizing screw 1 according to FIGS. 2 and 3. Specifically, this plasticizing screw 1 comprises a screw tip 4 and three wings 9 with the surfaces 23. The conical section 27 of the neck region 26 is visible in the region of the longitudinal channels between the lateral surfaces 24 and 25. In addition, the second limit stop surface A7 is visible. Further, the shut-off ring 8 and its screw tip abutting surface A8 are illustrated. The outermost circular line illustrates the inner wall 12i of the plasticizing cylinder 12.

The section line A-A is marked in FIG. 4. The section plane (including the longitudinal axis L) resulting from this section line A-A is illustrated schematically and simplified in FIG. 5. Especially, it is visible that the first limit stop surface A6 forms a convex curve K. This convex curve K forms a pitch circle with the radius r.

The center of this pitch circle is located distanced (or spaced) from the longitudinal axis L. In a preferred embodiment the radius r is between 10 mm and 700 mm.

Different than illustrated in FIG. 5, the convex curve K can also comprise several sections with different radii. Correspondingly, it is schematically illustrated in FIG. 5a that the convex curve K has two curve sections K1 and K2 with different radii. Accordingly, a first (relative to the longitudinal axis L) radially inner curve section K1 has a larger radius than a second (relative to the longitudinal axis L) radially outer curve section K2.

In FIG. 4, also the section line B-B is marked. This section line B-B corresponds to a section plane in the form of a cylinder jacket which is formed around the longitudinal axis L. When this section plane in the form of a cylinder jacket is outspread and “pressed flat”, this results in the schematically and simplified illustrated section plane B-B according to FIG. 6. As this section plane B-B mainly leads through the wings 9 and the shut-off ring 8, the corresponding components can be seen in FIG. 6. Specifically, the sections through the three wings 9 are illustrated, wherein each of these wings 9 comprises the two lateral surfaces 24 and 25, the conical surface 23 and the first limit stop surface A6. The shut-off ring 8 especially comprises the screw tip abutting surface A8 and the base element abutting surface A3. As illustrated in FIG. 6, the first limit stop surface A6 also in this section plane B-B has the form of a convex curve K. This convex curve K has the form of a pitch circle with the radius r. In a preferred embodiment this radius r is between 10 mm and 700 mm. Different than illustrated, the convex curve K can also have several sections with different radii. For example, it can be provided that a first curve section which is centrally arranged between the lateral surfaces 24 and 25 of the wing 9 jointly forming the first limit stop surface A6 has a smaller radius r than two second curve sections which are located nearer to the lateral surface 24 and 25. This means, the first limit stop surface A6 is flatter or less curved in a region which is near to the lateral surfaces than in the central region. Of course, this can also be formed conversely.

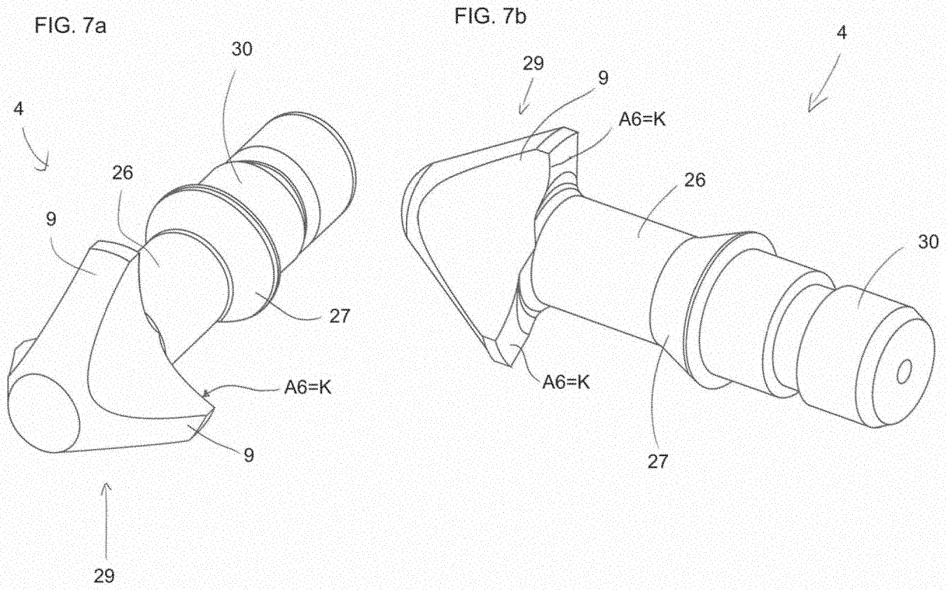

FIGS. 7a and 7b show perspective views of the screw tip 4 from different angles. The (fin-shaped) wings 9 directly merge in the tip of the screw tip 4 and form a displacement body 29. The shut-off ring 8 is not illustrated in FIG. 7. This shut-off ring 8 would be arranged around the small neck region 26 of the screw tip 4. The base element 3 is missing in these FIGS. 7a and 7b too. However, also the connection region 30 is illustrated in the FIGS. 7a and 7b. For example, this connection region 30 can comprise an external thread which corresponds with an internal thread formed in the base element 3. It is also illustrated in FIGS. 7a and 7b that the first limit stop surface A6 has a convex curvature.

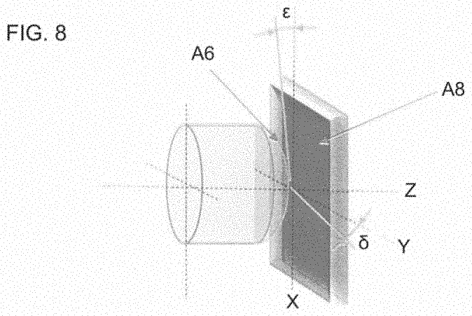

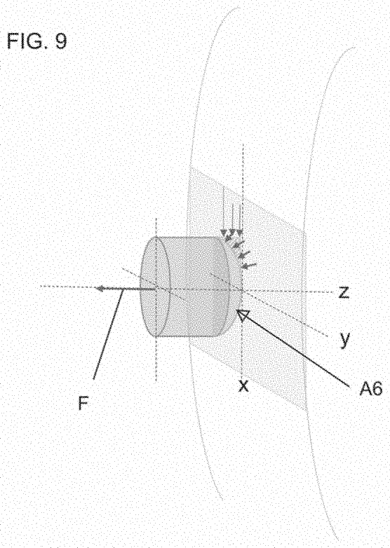

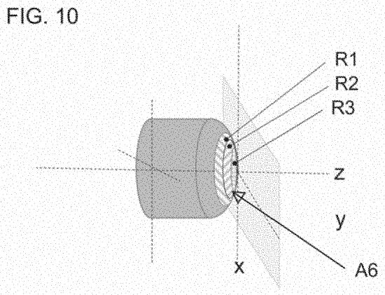

FIG. 8 schematically illustrates the ball-like surface form of the limit stop surface A6. The spatial axis Z is oriented parallel to the longitudinal axis L. The two additional spatial axes X and Y are oriented rectangular to each other and are each rectangular to the spatial axis Z. The convex curvature of the first limit stop surface A6 is formed in a way which results in the angle δ relative to the spatial axis Y and in the angle ε relative to the spatial axis X.

FIG. 9 illustrates the ball-like surface form of the limit stop surface A6 just like FIG. 8. This ball-like surface or partial sphere surface allows an all-round uplift because the pressure occurring during closing can act onto the entire sphere surface. This pressure occurring during closing of the return flow shut-off device 5 (indicated in FIG. 9 by seven arrows) acts on all sides onto the limit stop surface A6. The shut-off ring 8 is raised from the wings 9 by this process, whereby the return flow shut-off device 5 closes very fast. The arrow with the reference sign F represents the resulting force F.

In FIG. 10, in turn, the limit stop surface A6 is illustrated as a partial sphere surface. The limit stop surface A6 can be made of at least two different materials each having a different wear resistance. For example, the hardness is a substantial parameter for the wear (or abrasion). Specifically, the layers R1, R2 and R3 (illustrated as concentric rings)—consisting of different powders—are welded onto the surface. This leads to different abrasion properties. The lifetime is determined by the hardest layer R3. This layer R3 has the highest resistance against wear. The layers R2 (middle concentric ring) and R3 (outermost concentric ring) which are located further outward have a smaller and decreasing abrasion resistance. These layers R2 and R3, thus, already wear in the case of a smaller resistance. By way of this structure a constant abrasion of the limit stop surface A6 is reached so that a sphere-like surface remains also after a longer operating time. By this maintenance of the convex form (sphere surface) the pressure (described in FIG. 9) is still acting all-round, whereby the closing properties of the return flow shut-off device 5 remains over the whole lifetime on a high level.

Referring to FIG. 10, the center of the concentric layers R1, R2 and R3 forms the point of the (partial) sphere surface of the limit stop surface A6 which is nearest to the shut-off ring 8. In this case, the center point which has the largest distance to the edge coincides with the point which is nearest to the shut-off ring 8. In addition, in this embodiment the sphere center point has the same distance to the longitudinal axis L (extending in the direction z) as the point which is nearest to the shut-off ring 8.

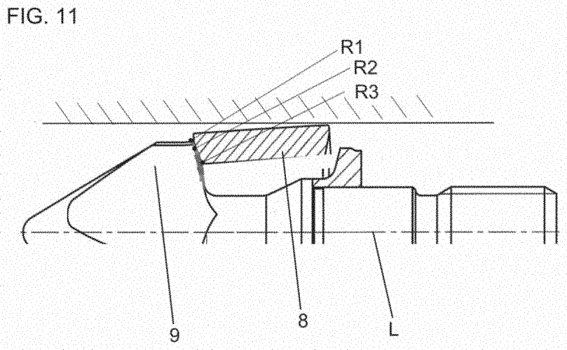

FIG. 11 is a cross section of the return flow shut-off device 5 together with the shut-off ring 8, wherein the shut-off ring 8 is illustrated in a (slightly exaggerated) inclined position. The limit stop surface A6 of the wing 9 comprises the layers R1, R2 and R3, each having a different hardness. In this case, the layer R1 can consist of the base material (for example steel). The hardness of the layer R2 is larger than the hardness of the layer R1. The hardness of the layer R3, in turn, is larger than the hardness of the layer R2. The closer the layer is located to the longitudinal axis L, the larger is the hardness of the layer. The layers R1, R2 and R3 are each arranged (partially) circular around the longitudinal axis L.

### LIST OF REFERENCE SIGNS

1 plasticizing screw
2 molding machine
3 base element
4 screw tip
5 return flow shut-off device
6 first, anterior limit stop
7 second, posterior limit stop
8 shut-off ring
9 wings
10 screw flight
11 injection aggregate
12 plasticizing cylinder
12i inner wall of the plasticizing cylinder
13 closing unit
14 drive device for the plasticizing screw
15 feed hopper
16 stationary mold mounting plate
17 movable mold mounting plate
18 mold tool
19 front plate
20 drive device for the movable mold mounting plate
21 injection channel
22 screw pre-chamber
23 surface of the wings
24 lateral surface of the wings
25 lateral surface of the wings
26 neck region
27 conical section
29 conical displacement body
30 connection region
A3 base element abutting surface
A6 first limit stop surface
A7 second abutting surface
A8 screw tip abutting surface
L longitudinal axis
E direction of injection
K convex curve
K1 first curve section
K2 second curve section
Za outer surface in the form of a cylinder jacket
Zi inner surface in the form of a cylinder jacket
C cavity
s distance of the shut-off ring to the plasticizing cylinder
L_{Z} longitudinal axis of the plasticizing cylinder
β angle of the tumbling motion of the longitudinal axis L about the longitudinal axis L_{Z}
α angle of the tumbling motion of the shut-off ring
r radius of the convex curve K of the first limit stop surface A6
δ angle to the spatial axis y
ε angel to the spatial axis x
X spatial axis
Y spatial axis
Z spatial axis
F resulting force
R1 layer
R2 layer (with medium hardness)
R3 (hardest) layer

1. A plasticizing screw for a molding machine, in particular an injection molding machine or an injection press, comprising:
a base element which is stretched along a longitudinal axis,
a screw tip which is connected to the base element, wherein the screw tip is arranged—in the direction of injection—after the base element, and
a return flow shut-off device, wherein the return flow-shut off device comprises a first—in the direction of injection—anterior limit stop, a second—in the direction of injection—posterior limit stop and a shut-off ring being movable in a limited manner between the two limit stops along the longitudinal axis, wherein the at least one first, anterior limit stop comprises a first limit stop surface facing towards the base element and the shut-off ring and wherein the shut-off ring comprises a ring-shaped screw tip abutting surface facing towards the first, anterior limit stop, wherein the screw tip abutting surface is formed rotationally symmetric around the longitudinal axis,
wherein the first limit stop surface comprises a convex curvature facing towards the shut-off ring.

2. The plasticizing screw as set forth in claim 1, wherein the screw tip comprises several radially protruding wings, preferably the wings having constant distances to each other.

3. The plasticizing screw as set forth in claim 2, wherein each wing jointly forms a first, anterior limit stop.

4. The plasticizing screw as set forth in claim 1, wherein the convex curvature is formed in such a way that in a sectional plane which includes the longitudinal axis the first limit stop surface at least in sections forms a convex curve.

5. The plasticizing screw as set forth in claim 4, wherein the convex curve has a continuous radius, preferably between 10 mm and 700 mm.

6. The plasticizing screw as set forth in claim 4, wherein the convex curve has at least two curve sections with different radii.

7. The plasticizing screw as set forth in claim 6, wherein a first curve section—arranged on a radially inner position relative to the longitudinal axis—has a larger radius than a second curve section arranged on a radially outer position relative to the longitudinal axis.

8. The plasticizing screw as set forth in claim 1, wherein the convex curvature is formed in such a way that in a sectional plane—which is formed as a cylinder jacket around the longitudinal axis—the first limit stop surface at least in sections forms a convex curve.

9. The plasticizing screw as set forth in claim 8, wherein the radius of the convex curve is in a range between 0.5 times the nominal diameter of the plasticizing screw and 2.5 times the nominal diameter of the plasticizing screw.

10. The plasticizing screw as set forth in claim 1, wherein the screw tip abutting surface has a concave curvature, preferably in the form of a negative torus surface.

11. The plasticizing screw as set forth in claim 10, wherein the screw tip abutting surface is evenly formed.

12. The plasticizing screw as set forth in claim 11, wherein the even screw tip abutting surface forms a plane which is oriented rectangular to the longitudinal axis.

13. The plasticizing screw as set forth in claim 10, wherein the shut-off ring—additionally to the screw tip abutting surface—comprises a ring-shaped base element abutting surface facing towards the second limit stop, an outer surface in the form of a cylinder jacket and an inner surface in the form of a cylinder jacket.

14. The plasticizing screw as set forth in claim 1, wherein the base element and the screw tip are formed as separate components, wherein the screw tip is detachably connected to the base element, preferably by means of a screw connection.

15. The plasticizing screw as set forth in claim 1, wherein a helical screw flight is formed on the base element.

16. An injection aggregate for a molding machine, comprising a plasticizing cylinder and the plasticizing screw as set forth in claim 1 rotatably arranged inside the plasticizing cylinder—in particular the plasticizing screw being movable along the longitudinal axis.

17. A molding machine comprising a closing unit and the injection aggregate as set forth in claim 16.
